(19) United States
(12) Patent Application Publication
(10) Pub. No.: US 2026/0289074 A1
(43) Pub. Date: Sep. 24, 2026

(54) IMPROVED METHOD FOR GENERATING PATENT TEXT USING LARGE LANGUAGE MODELS AND STRUCTURED DATA CONCEPTS

(71) Applicant: LIGHTBRINGER AB, Lund (SE)

(72) Inventors: Markus ANDREASSON, Lund (SE); Dominic DAVIES, Lomma (SE)

(73) Assignee: LIGHTBRINGER AB, Lund (SE)

(21) Appl. No.: 19/474,369

(22) PCT Filed: Apr. 12, 2024
(86) PCT No.: PCT/SE2024/050349

§ 371 Date: Oct. 10, 2025

(30) Foreign Application Priority Data
Apr. 12, 2023 (SE) 2330159-1

(51) Int. Cl. G06F 40/166; G06F 40/30; G06F 40/56

(52) U.S. Cl. CPC G06F 40/166; G06F 40/30; G06F 40/56

(57) ABSTRACT

A system for generating long-form documents using large language models (LLMs) includes a memory, a processor programmed to operate a software comprising a text description input component configured to collect a text description of an idea, a data structure conversion component configured to convert the text description of the idea into a data structure of concepts, an augmentation component configured to augment the data structure of concepts to add concepts and clarify concepts, and a document generation component configured to generate high quality long-form documents using the data structure of concepts in the AI prompts of the LLM. The system enables the creation of detailed and coherent documents, such as patent applications, based on the input text description and the data structure of concepts.

### FIELD

This technology relates to the field of artificial intelligence, specifically natural language processing and generation, as well as patent document generation and management.

### BACKGROUND

The present invention relates generally to the field of patent text generation, and specifically, to a system and method for generating high-quality patent texts, which utilize large language models (LLMs) to convert, augment, and refine a data structure of concepts based on the input text description of an idea.

Patent text generation is an essential aspect of the process of patent application filing, which involves the proper formatting, organization, and presentation of an invention in a manner that meets the stringent requirements set forth by patent offices. Traditionally, the generation of patent texts requires significant effort, time, and expertise, as it demands a thorough understanding of the invention, its technical details, domain-specific language, and legal implications.

In recent years, there have been numerous attempts to automate and streamline the patent text generation process. Conventional approaches often involve rule-based systems, templates, or simple natural language processing (NLP) techniques. While these methods can help in certain cases, they often fall short in generating comprehensive, coherent, and high-quality patent texts, particularly for complex inventions with nuanced details.

Furthermore, these prior art methods face challenges in processing and understanding the complex language used in patent documents, which often include technical jargon, legal terminology, and domain-specific vocabulary. Additionally, maintaining coherence and consistency throughout the long-form document generation process is a considerable challenge inherent in the prior art.

With the advent of artificial intelligence (AI), particularly large language models (LLMs) like GPT-3.5 and GPT-4, there has been a growing interest in leveraging these technologies to improve patent text generation. LLMs hold significant promise in addressing the limitations of conventional approaches, as they can understand, manipulate, and generate coherent text based on diverse input data. However, the potential of LLMs in patent text generation is yet to be fully realized.

Therefore, there is a significant need to develop advanced methods for generating high-quality patent texts that effectively utilize LLMs in conjunction with a well-structured data model representing the concepts and relationships within a given invention.

### SUMMARY

According to a first aspect of the disclosure, a system for generating long-form documents using large language models (LLMs) is provided. This system comprises a memory, a processor programmed to operate a software that includes a text description input component, a data structure conversion component, an augmentation component, and a document generation component. The text description input component is configured to collect a text description of an idea. The data structure conversion component is configured to convert the text description of the idea into a data structure of concepts. The augmentation component is configured to augment the data structure of concepts to add concepts and clarify concepts. The document generation component is configured to generate high-quality long-form documents using the data structure of concepts in the AI prompts of the LLM. This system provides the advantage of automating the process of generating long-form documents, such as disclosure applications, thereby saving time and reducing the potential for human error.

Optionally in some examples, the text description input component is configured to collect the text description of the idea through various methods. These methods can include entering text manually into a web interface, uploading a document containing the text description, importing data from other software applications, extracting text from a web page or other online source, and using a mobile app to capture and submit the text description. This provides the advantage of flexibility in how the text description of an idea is collected, making the system more accessible and user-friendly.

Optionally in some examples, the data structure of concepts can take various forms. These forms can include a hierarchical tree structure, a semantic graph network, an ontology, an entity-relationship model, a natural language graph, a conceptual database schema, a concept map, a mind map, a topic map, semantic web annotations, JSON, and XML. This provides the advantage of versatility in how the data structure of concepts is represented, allowing the system to be adaptable to different types of text descriptions and ideas.

Optionally in some examples, the data structure conversion component is configured to convert the text description of the idea to the data structure of concepts using the LLM. This provides the advantage of leveraging the capabilities of the LLM to understand and interpret the text description, resulting in a more accurate and comprehensive data structure of concepts.

Optionally in some examples, the augmentation component is configured to utilize machine learning algorithms to automatically identify and add concepts to the data structure. This provides the advantage of enhancing the data structure of concepts with additional relevant concepts, thereby improving the quality and completeness of the generated long-form documents.

Optionally in some examples, the document generation component is configured to generate a detailed disclosure application text using the data structure of concepts as a guide and using the LLM to fill in relevant details and phrasing. This provides the advantage of producing high-quality disclosure applications that are comprehensive and well-structured, increasing the likelihood of successful disclosure approval.

Optionally in some examples, the document generation component is configured to generate variations of the long-form disclosure text based on different parameters. This provides the advantage of creating multiple versions of the disclosure text tailored to different requirements or audiences, thereby increasing the utility and applicability of the generated documents.

Optionally in some examples, the document generation component is configured to automatically generate diagrams or visual representations of the idea described in the disclosure text using the data structure of concepts. This provides the advantage of enhancing the understanding and interpretation of the disclosure text with visual aids, making the generated documents more informative and engaging.

Optionally in some examples, the document generation component is configured to provide suggestions for additional claims based on the concepts identified in the text description. This provides the advantage of ensuring that all potential aspects of the Idea are covered in the disclosure application, thereby maximizing the protection provided by the disclosure.

Optionally in some examples, the document generation component is configured to identify potential legal or technical issues that may arise based on the contents of the disclosure text. This provides the advantage of proactively addressing potential challenges or obstacles in the disclosure approval process, thereby increasing the likelihood of successful disclosure approval.

Optionally in some examples, the document generation component is configured to generate summaries or abstracts of the disclosure text using the data structure of concepts as a guide. This provides the advantage of creating concise and informative summaries of the disclosure text, making the generated documents more accessible and easier to understand.

Optionally in some examples, the document generation component is configured to automatically generate a table of contents and index for the long-form disclosure text based on the concepts identified in the data structure. This provides the advantage of improving the organization and navigability of the generated documents, making them more user-friendly and efficient to use.

Optionally in some examples, the system further comprises a training dataset comprising a collection of legal documents, disclosure publications, and technical documents. The LLM is trained on the training dataset to improve its understanding of relevant topics and language. This provides the advantage of enhancing the performance and accuracy of the LLM in generating long-form documents, thereby improving the quality of the generated documents.

According to a second aspect of the disclosure, a method of generating a disclosure text using an AI is provided. This method comprises the steps of collecting a text description of an idea, converting the text description to a data structure of concepts, augmenting the data structure of concepts, and generating long-form documents using the data structure of concepts. This method provides the advantage of automating the process of generating disclosure texts, thereby saving time and reducing the potential for human error.

Optionally in some examples, the step of collecting the text description of an idea can be performed through various methods. These methods can include entering text manually into a web interface, uploading a document containing the text description, importing data from other software applications, extracting text from a web page or other online source, or using a mobile app to capture and submit the text description. This provides the advantage of flexibility in how the text description of an idea is collected, making the method more accessible and user-friendly.

Optionally in some examples, the data structure of concepts can take various forms. These forms can include a hierarchical tree structure, a semantic graph network, an ontology, an entity-relationship model, a natural language graph, a conceptual database schema, a concept map, a mind map, a topic map, semantic web annotations. This provides the advantage of versatility in how the data structure of concepts is represented, allowing the method to be adaptable to different types of text descriptions and ideas.

Optionally in some examples, the step of converting the text description of an idea to a data structure of concepts utilizes a large language model (LLM). This provides the advantage of leveraging the capabilities of the LLM to understand and interpret the text description, resulting in a more accurate and comprehensive data structure of concepts.

Optionally in some examples, the step of augmenting the data structure of concepts comprises utilizing machine learning algorithms to automatically identify and add concepts to the data structure, evaluating the existing data structure for completeness, adding missing concepts, or removing irrelevant concepts, or identifying relationships between concepts and adding those relationships to the data structure. This provides the advantage of enhancing the data structure of concepts with additional relevant concepts, thereby improving the quality and completeness of the generated long-form documents.

Optionally in some examples, the step of generating long-form documents using the data structure of concepts is performed by an LLM that has been trained on a diverse and extensive set of disclosure documents or structured documents. This provides the advantage of producing high-quality disclosure applications that are comprehensive and well-structured, increasing the likelihood of successful disclosure approval.

Optionally in some examples, the LLM used in the method is selected from the group consisting of GPT-3.5 and GPT-4. This provides the advantage of leveraging the latest advancements in AI and machine learning to generate high-quality long-form documents.

Optionally in some examples, generating long-form documents using the data structure of concepts further comprises creating a detailed disclosure application using the data structure of concepts as a guide, generating variations of the long-form disclosure text based on different parameters, automatically generating diagrams or visual representations of the idea, providing suggestions for additional claims, identifying potential legal or technical issues, generating summaries or abstracts of the disclosure text, or automatically generating a table of contents and index for the long-form disclosure text. This provides the advantage of creating comprehensive and well-structured disclosure applications that cover all aspects of the idea, thereby maximizing the protection provided by the disclosure.

Optionally in some examples, the AI generating the disclosure text is an LLM, the LLM being trained on a training dataset comprising legal documents, disclosure publications, technical documents, scientific papers, or technical manuals. This provides the advantage of enhancing the performance and accuracy of the LLM in generating disclosure texts, thereby improving the quality of the generated documents.

### BRIEF DESCRIPTION OF THE DRAWINGS

The disclosure will now be described in more detail with reference to the accompanying drawings, in which:

FIG. 1 is a flowchart illustrating the overall process of generating a patent text using a LLM.

FIG. 2 is a system diagram according to an example of the disclosure.

### DETAILED DESCRIPTION

The present disclosure will now be described in detail with reference to example examples. It should be understood that these example examples are provided for illustrative purposes only and are not intended to limit the scope of the present disclosure.

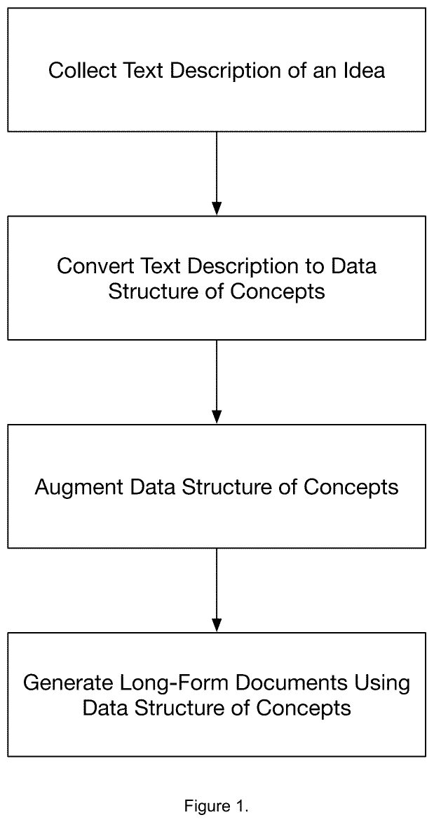

According to an example shown in FIG. 1, a method of generating a patent text using a system 100 is provided. The method comprises four main steps, including collecting a text description of an idea, converting the text description to a data structure of concepts, augmenting the data structure of concepts, and generating long-form documents using the data structure of concepts. A patent text may be defined as at least part of a draft patent application organized within a patent application including one or more sections such as background, summary, detailed description, claims, and abstract.

In the first step, as shown in FIG. 1, a text description of an idea is collected. This can be done in several ways, such as entering text manually into a web interface, uploading a document containing the text description, importing data from other software applications, extracting text from a web page or other online sources, or using a mobile app to capture and submit the text description. A text description of an idea is a written narrative provided by an inventor or a user that summarizes the inventive concept, including its functional features and potential applications. A typical example of a text description of an idea may be an ‘invention disclosure’ used in academic and corporate environments to record the details of a new invention or innovation.

In the second step, illustrated in FIG. 1, the collected text description of the idea is converted to a data structure of concepts. The data structure can be of various types, including hierarchical tree structures, semantic graph networks, ontologies, entity-relationship models, natural language graphs, conceptual database schemas, concept maps, mind maps, topic maps, semantic web annotations, and others. The conversion process can utilize large language models (LLM) to identify concepts and relationships found within the input text description. The data structure of concepts is derived from the text description of the idea and how it relates to the inventive concept. In one example, a text description of the idea describing a mechanical invention comprising a collection of interacting components is converted into a hierarchal data structure describing the structure of the mechanical invention, the components and sub-components of the mechanical invention, and the relationship of each component to other components in the mechanical invention. In this example, the large language model determines the interrelationships of each component and the hierarchical configuration of the components in the mechanical invention. The hierarchal data structure is then stored in the memory of the system 100. In some examples, other types of invention can be used in other technical fields e.g. software, chemistry, biotechnology, electronics or indeed any patentable technology field. In some examples, the step of converting the collected text description to the data structure comprises using the LLM to prioritize features of the inventive concept in to the hierarchical structure, with the more important features higher in the hierarchical structure. In some examples, the step of converting the collected text description to the data structure comprises perform multiple iterations in order to add further nodes, subnodes or information to the hierarchical data structure. In some examples, the LLM processes the collected text description and assigns a priority weighting one or more features based on additional context information. In some examples, the LLM processes the collected text description and assigns a priority weighting one or more features based predetermined parameters e.g. a word frequency, a proximity to one or more key words, additional context information assigned a predetermined text classification e.g. problem, solution, etc. In some cases additional context information can be text added manually or other information added manually such as a hierarchical position of information in the data structure.

In the third step, as shown in FIG. 1, the data structure of concepts is augmented using various techniques. These techniques may include utilizing machine learning algorithms to automatically identify and add concepts to the data structure, evaluating the existing data structure for completeness and adding missing concepts or removing irrelevant concepts, and identifying relationships between concepts and adding those relationships to the data structure. This can be carried out manually by the user or additionally or alternatively, a process carried out by the LLM. In some examples, the LLM can augment the data structure based on additional context information.

In the fourth step, as seen in FIG. 1, long-form documents are generated using the data structure of concepts. This process is performed by an LLM that has been trained on a diverse and extensive set of patent documents or structured documents. Various outputs can be generated in this step, such as creating a detailed patent application using the data structure of concepts as a guide, generating variations of the long-form patent text based on different parameters, automatically generating diagrams or visual representations of the idea, providing suggestions for additional claims, identifying potential legal or technical issues, generating summaries or abstracts of the patent text, and automatically generating a table of contents and index for the long-form patent text. In the present disclosure, long-form documents are defined as documents that include the necessary sections and elements of a draft patent application, formatted according to a predefined template, and designed to meet patent filing requirements. The step of generating long-form documents may be performed in an iterative manner, in which sections of the long-form documents are generated first and then used to generate further sections of the long-form document.

In this example, the AI generating the patent text is an LLM, which is trained on a training dataset that includes, but is not limited to, legal documents, patent publications, technical documents, scientific papers, or technical manuals. This training dataset provides the LLM with contextual information and helps build its contextual understanding, allowing it to generate high-quality patent texts using the method described above.

These example examples demonstrate various aspects of the present disclosure, including the use of AI, specifically LLMs, as well as different data structures and augmentation techniques. It should be understood that these examples are for illustrative purposes and are not intended to limit the scope of the present disclosure. One skilled in the art would appreciate that various modifications and changes may be made without departing from the spirit and scope of the disclosure. In the present disclosure, ‘AI’may be understood to mean a natural language processing module.

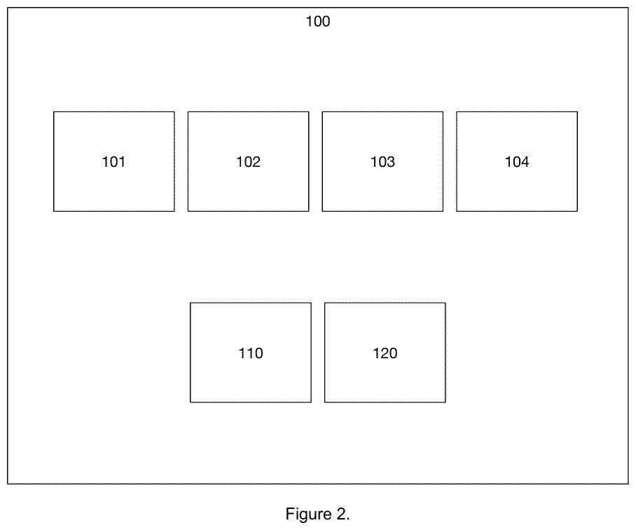

FIG. 2 illustrates a system according to an example of the present disclosure. The system may include the following components:
1. Processor 110: This is the central unit that executes the instructions of the system software to carry out the patent text generation process. It orchestrates the activities of various components, processes data, and executes the algorithmic steps of the method. In some examples, the processor 110 and the memory 120 are located near the user e.g. in a local terminal. However in other examples, the processor 110 and memory are a remote terminal e.g. on a cloud based system. In some examples, one or more processors 110 can be located locally or remotely from the user.
2. Memory 120: This component stores the operational software, including the algorithms governing the process of text collection, concept structuring, augmentation, and document generation. It also temporarily holds the data during processing.
3. Text Description Input Component 101: This interface allows for the collection of the text description of an idea from users. It may support various input methods, such as a web interface, document uploads, data imports, text extractions from web sources, or mobile app submissions. In some examples, the Text Description Input Component 101 may be received from a manual additional context information. In other examples, the Text Description Input Component 101 can be received from an automated process e.g. OCR of a pre-existing document. For example, the Text Description Input Component 101 can be received from an existing document such as an invention disclosure form. This could be a physical document that is scanned or an electronic document.
4. Data Structure Conversion Component 102: This component processes the collected text description and converts it into a structured data model of concepts, potentially utilizing an LLM to identify and organize the key elements of the idea into a format suitable for further processing.
5. Augmentation Component 103: Following the creation of the initial data structure, this component enhances and refines it by adding new concepts, clarifying existing ones, and establishing relationships among them, potentially using machine learning algorithms to spot gaps or missing elements. In some examples, the Augmentation Component 103 enhances the initial data structure with additional context information. Additionally or alternatively, the Augmentation Component 103 enhances the initial data structure using additional context information together with an LLM.
6. Document Generation Component 104: Utilizing the augmented data structure, this component employs an LLM to generate long-form patent documents, which can include a complete detailed patent application, various document sections, abstracts, summaries, and visual content like diagrams. In some examples. The Document Generation Component 104 uses a preexisting template for a draft patent application document and the long-form patent document is generate by inserting generated text in various document sections of the preexisting template.
8. Communication Means: The system would also include ways to communicate with external data sources, databases, cloud storage, or interfaces for data import/export functions (not specifically shown in the figure).
9. User Interface (UI): Although not detailed in the figure, the system would also include a user interface for interaction between the users and the system, such as text entry, reviewing generated documents, or providing feedback (not specifically shown in the figure).

### Collecting Text Description of an Idea

The present disclosure provides a method for collecting a text description of an idea, which is the first step in generating a patent text using an AI. The collection process may involve various techniques, allowing users to easily and efficiently submit their ideas in the form of text descriptions. The collected text descriptions may be used as input for subsequent steps in the patent text generation process.

The collection process may comprise several optional approaches for entering and submitting the text description of an idea, as shown in FIG. 1. These options provide flexibility for users and cater to different scenarios, environments, and preferences.

One optional approach for collecting the text description is through manual entry via a web interface. The web interface may be designed with a user-friendly text editor, allowing users to type or paste their idea's description directly into the designated input field. The interface may include features such as formatting options, word count display, and “save draft” capabilities for user convenience.

Another optional approach for collecting the text description is by uploading a document containing the description. Users may prepare their ideas in their preferred text-processing software and save them as documents in formats such as Word, PDF, or plain text files. The upload feature may allow users to browse and select the desired document from their local storage or connected cloud storage services for submission.

A further optional approach for collecting the text description is by importing data from other software applications. This may involve integrating the patent text generation system with third-party tools and platforms, such as project management or collaboration tools, where ideas and their descriptions are typically documented. Users may select the relevant text description data from the integrated sources and import them directly into the patent text generation system.

Additionally, an optional approach to collecting the text description is by extracting text from a web page or an online source using a browser extension or API. With this feature, users may capture and submit the text descriptions found on websites, online articles, or other digital sources. The browser extension or API may provide built-in functionality to select and extract the relevant text, which is then submitted to the patent text generation system.

Another optional approach for collecting the text description is by using a mobile app for capturing and submitting the text description. The mobile app may allow users to enter the idea's description via the device's virtual keyboard or by leveraging speech-to-text functionality for converting spoken words into text. The mobile app may also support importing text from other apps, capturing text from images or documents using optical character recognition (OCR) technology, or receiving shared text from other devices and applications.

In some implementations, the collecting step may also involve pre-processing the collected text descriptions. This pre-processing may include, but is not limited to, removing unnecessary white spaces, correcting typographical errors, converting special characters, and tokenizing the text into sentences, phrases, or words using natural language processing techniques. Such pre-processing may improve the accuracy and efficiency of subsequent steps in the patent text generation process.

The various optional features and approaches described above for collecting the text description of an idea offer flexibility and convenience for users, ensuring a smooth and efficient patent text generation process. While these optional approaches may be used individually or in various combinations, other alternatives and modifications are possible without departing from the spirit and scope of the disclosure. One skilled in the art would appreciate that numerous changes and adjustments can be made to suit the specific requirements of different scenarios and users.

### Data Structure of Concepts and Types

This section of the detailed description elaborates on the various types and features of data structures that may be used in the process of generating patent texts using AI, specifically LLMs. For this purpose, the method for generating a patent text may comprise converting the text description of an idea into a data structure of concepts, as illustrated in FIG. 1. The data structure of concepts is a component, as it holds information related to the idea described in the collected text description and provides a foundation for further processing in subsequent steps.

The data structure of concepts, as mentioned earlier, may comprise a wide range of alternative and optional structures. These structures can be selected based on the specific requirements and preferences of a user or an AI. Some of the optional types of data structures that may be utilized in this method include, but are not limited to:
1. Hierarchical tree structure: These data structures represent relationships between concepts in a hierarchy or tree-like format, allowing for easy visualization and understanding of the connections between the concepts. For instance, parent and child nodes may represent different levels of abstraction or importance, while sibling nodes may represent concepts of equal importance.
2. Semantic graph network: This data structure represents concepts and their relationships as nodes and edges in a graph. Semantic graph networks are particularly useful for representing complex relationships between concepts and can be easily traversed and analyzed by AI algorithms.
3. Ontology: An ontology is a formal representation of knowledge, typically in the form of a set of concepts and the relationships between them. Ontologies are often used in AI applications to model or classify complex structures, such as natural language or technical documentation.
4. Entity-relationship model: This data structure represents concepts as entities and their relationships as the links between them. Entity-relationship models are particularly useful for organizing information about specific entities, such as people, organizations, or products, and their associated attributes and properties.
5. Natural language graph: This data structure represents the syntax and semantic relationships of natural language texts, often using graph theory techniques. Natural language graphs may be useful for processing, understanding, and generating text-based content, such as patent descriptions or claims.
6. Conceptual database schema: This type of data structure represents the conceptual structure of a database, including its entities, relationships, and attributes. A conceptual database schema may be useful for organizing and structuring the knowledge extracted from a text description into a format that is compatible with AI-based processing.
7. Concept map: Concept maps visually represent the relationships between concepts using nodes and connecting lines or arrows, with labeled relationships indicating the nature of the connection between the concepts. Concept maps can facilitate the organization and presentation of complex information in a concise and visually appealing way.
8. Mind map: Mind maps are similar to concept maps in that they visually represent the relationships between concepts. However, mind maps generally have a radial structure with a central node representing the main idea or topic and branching nodes representing subtopics or related concepts.
9. Topic map: A topic map is a data structure used to organize and present the relationships between concepts based on their association with specific topics or themes. Topic maps are particularly useful for indexing and navigating large collections of content, such as patent documents or technical literature.
10. Semantic web annotations: Semantic web annotations are metadata added to web resources, such as web pages or documents, to provide more explicit and machine-readable information about the content. These annotations can be useful for extracting and structuring information about concepts and relationships found in online sources related to the patent description.

The data structure of concepts may comprise one or more of these optional types, depending on the specific needs and objectives of the patent text generation process. Additionally, the data structure of concepts may be converted into various formats, such as JSON or XML, to enable efficient processing, storage, and transfer of the structured information between different software applications or systems. This flexibility in the choice of data structure types and storage formats allows for greater adaptability and customization, ensuring the most suitable and efficient organization and representation of the concepts and relationships within the text description of an idea.

### Converting Text to Data Structure Using LLMs

This section describes the process of converting a text description of an idea into a data structure of concepts using large language models. The conversion process may be performed utilizing various techniques and features, each of which may be optional, and the examples provided herein exemplify some of these techniques and features. The conversion process may be applied to text descriptions collected using different methods, such as those described in the “Collecting Text Description of an Idea” section.

In the conversion process, a large language model may be utilized to analyze the text description, which may be collected as described in the “Collecting Text Description of an Idea” section. The LLM may be selected from several possible models, including but not limited to, GPT-3.5, GPT-4, or other models known to those skilled in the art. The LLM may be pre-trained on a diverse dataset, potentially including legal documents, patent publications, technical documents, scientific papers, or technical manuals. This pre-training may help improve the contextual understanding of the LLM.

The LLM, as part of the conversion process, may be used to identify concepts and relationships within the input text description. The LLM may utilize natural language processing techniques, machine learning algorithms, pattern recognition, or other approaches to perform this task. The identified concepts and relationships may be extracted and used to create a data structure of concepts.

The data structure of concepts that may be generated by the LLM may take various forms, including but not limited to hierarchical tree structures, semantic graph networks, ontologies, entity-relationship models, natural language graphs, conceptual database schemas, concept maps, mind maps, topic maps, semantic web annotations, JSON, or XML. The choice of data structure may depend on the specific requirements or desired features of the generated patent text, as well as the type of LLM used and other factors.

The LLM may also identify relationships between concepts and include these relationships in the data structure. These relationships may be explicit, such as direct associations or connections between concepts, or implicit, such as inferred relationships based on context, word usage patterns, or other indications. These relationships may help provide additional context and structure to the data structure of concepts, facilitating a more accurate and coherent long-form patent document generation process.

In addition to identifying concepts and relationships, the LLM may be used to extract and include other types of information in the data structure. This additional information may include but is not limited to contextual clues, inferred knowledge, connections to related patents or publications, or identification of novel aspects of the idea. By incorporating these additional elements into the data structure, the LLM may further enhance its understanding of the text description and enable more accurate and comprehensive long-form patent document generation.

The LLM may utilize various techniques to optimize the conversion process and ensure that the resulting data structure of concepts is accurate and useful for subsequent steps of generating long-form patent documents. These techniques may include, but are not limited to, error detection and correction, iterative refinement of the data structure based on feedback loops, and integration of domain-specific knowledge or resources to enhance the LLM's understanding of specific contexts and ideas.

In summary, the process of converting a text description of an idea into a data structure of concepts using LLMs may comprise several optional features, each of which may contribute to the accuracy, completeness, and effectiveness of the resulting data structure. The accurate conversion of text descriptions into data structures of concepts using LLMs may facilitate the generation of high-quality, contextually relevant long-form patent documents, as discussed further throughout the other sections of this detailed description.

### Augmenting Data Structure of Concepts

Various techniques and processes may be employed in order to enhance, refine, and optimize the data structure of concepts resulting from the conversion of the text description of an idea. These techniques are used to improve the accuracy, relevance, and comprehensiveness of the data structure to ensure that the subsequent generation of long-form patent documents using this data structure produces high-quality, coherent, and well-structured output.

The augmentation process may comprise several optional features and approaches, each of which can be applied singly or in combination, depending on the specific requirements of a given application. The following aspects are possible features that may be included in the augmentation step:
1. Utilizing machine learning algorithms: The process of augmenting the data structure of concepts may comprise the use of one or more machine learning algorithms to analyze the data structure and automatically identify and add additional relevant concepts. These algorithms could include natural language processing techniques to identify key phrases and concepts in the text description and analyze previous patent filings in a similar field to identify common concepts.
2. Evaluating the existing data structure for completeness: The augmentation process may comprise examining the initial data structure for missing concepts or gaps in information and adding these to the data structure. This can ensure that the data structure offers a comprehensive representation of the text description and provides a solid foundation for the subsequent generation of long-form documents.
3. Removing irrelevant concepts: As part of the augmentation process, the method may comprise identifying and removing concepts that are irrelevant or detract from the overall understanding of the text description. This can help to focus the data structure on the most concepts and relationships and improve the coherence and effectiveness of the generated long-form patent documents.
4. Identifying relationships between concepts: To provide a more accurate representation of the text description, the augmentation process may comprise identifying relationships between various concepts within the data structure and adding these relationships explicitly. This can help to establish connections and dependencies that would otherwise be overlooked and give the data structure a greater depth and context.
5. Analyzing the frequency and relevance of concepts: The augmentation process may comprise applying machine learning algorithms to analyze the frequency and relevance of various concepts within the text description, helping to determine their importance within the data structure. This analysis can enable prioritization of key concepts and facilitate the generation of more targeted long-form patent documents.
6. Utilizing topic modeling techniques: The method of augmenting the data structure of concepts may employ topic modeling techniques to identify and group related concepts together within the data structure. This can contribute to a clearer organization of the data structure and improve the cohesiveness of the generated long-form patent documents.
7. Clustering algorithms: The augmentation process may comprise using clustering algorithms to identify patterns and correlations between concepts and adding those patterns to the data structure. This can help to reveal hidden relationships and connections, ultimately improving the accuracy and usefulness of the resulting long-form documents.
8. Sentiment analysis: The process of augmenting the data structure of concepts may comprise applying sentiment analysis techniques to the text description to determine the emotional tone or polarity of the description, and using this information to inform the choice and ordering of concepts within the data structure.
9. Named entity recognition: The augmented data structure of concepts may comprise utilizing named entity recognition methods to identify people, places, and organizations mentioned in the text description and adding them to the data structure. This can lead to a more precise representation of the ideas expressed in the text and enable the generation of more accurate and relevant long-form patent documents.

While each of these features may be considered optional, their combination may result in a more effective augmentation process that contributes to the overall improvement in the quality, accuracy, and relevance of the generated long-form patent documents. It is important to note that these features are provided for illustrative purposes, and one skilled in the art may employ various other techniques or approaches to augment the data structure of concepts without departing from the spirit and scope of the present disclosure.

### Long-Form Document Generation Process

The long-form document generation process is an aspect of the method for generating a patent text using artificial intelligence, particularly large language models. This section will provide a very detailed description of the long-form document generation process, outlining various optional features that may be utilized throughout the process. It should be understood that the features and techniques mentioned in this description are optional and may be used in various combinations, as desired, to enhance the quality, accuracy, and comprehensiveness of the generated patent text.

The long-form document generation process described herein may comprise various optional sub-processes, functionalities, and features as follows:
1. Input of Data Structure of Concepts: The process may comprise receiving the augmented data structure of concepts as input, which has been created previously in the method as described in the patent. The data structure of concepts may include various hierarchical or non-hierarchical representations of the idea, concept relationships, and additional information added during the augmentation step.
2. Selection of LLM: The process may comprise selecting an appropriate LLM for the generation of the long-form document. The LLM may be chosen from a group comprising GPT-3.5, GPT-4, or any other suitable LLM that has been trained on a suitable dataset comprising legal documents, patent publications, technical documents, scientific papers or technical manuals.
3. Initialization of Generation Process Using AI Prompts: The process may comprise initializing the LLM with AI prompts or guidance that are derived from the input data structure of concepts. These prompts may convey information about the idea or disclosure, its aspects, features, relationships, context, categories, or any other relevant data to aid the LLM in generating the long-form patent document.
4. Guided Long-Form Document Generation: The process may comprise generating the long-form document content using the LLM, while being guided by the data structure of concepts provided as input. The LLM may generate segments, paragraphs, or sections of the document based on the concepts, relationships, or additional information extracted from the input data structure. The LLM may utilize its training and contextual understanding to create high-quality, coherent, and accurate patent texts.
5. Fine-grained Control over Document Structure and Content: The process may comprise applying fine-grained control mechanisms over the generated document's structure, language, style, flow, or other aspects related to the patent content. This fine-grained control may involve specifying rules, guidelines, constraints, or preferences according to desired document characteristics, legal and technical requirements, formatting specifications, or any other relevant criteria.
6. Iterative Refinement and Editing: The process may comprise iteratively refining, editing, or modifying the generated long-form document content based on feedback, validation, or evaluation of the output document. This iterative refinement may help improve coherence, clarity, completeness, accuracy, and overall quality of the generated patent text.
7. Inclusion of Additional Document Elements: The process may comprise adding other elements of the patent document such as diagrams, visual representations, tables, figures, or examples as needed. These elements may be automatically generated or selected by the LLM based on the input data structure of concepts and the context or requirements of the patent text.
8. Validation and Compliance Checks: The process may comprise performing validation and compliance checks to ensure that the generated patent text adheres to legal, technical, formatting, or other relevant requirements specified for patent documents. This may include verifying the accuracy and completeness of the information, consistency of language and terminology, adherence to established formatting guidelines or templates, and compliance with applicable regulations or legal standards.
9. Optional Variations and Outputs: The process may comprise generating alternative versions or variations of the long-form patent text based on different parameters, such as language, industry, target audience, or other relevant factors. Additionally, the process may comprise generating summaries, abstracts, or other condensed representations of the patent text, or automatically generating a table of contents, index, or other navigational aids for the long-form document.

In summary, the long-form document generation process described herein may comprise various optional features and sub-processes that can enhance the quality, accuracy, comprehensiveness, and usability of the generated patent text. The process makes use of AI, specifically LLMs, in conjunction with the input data structure of concepts and other techniques to create a high-quality long-form patent document that meets the desired criteria, requirements, and preferences.

### Training Large Language Models for Patent Text Generation

This section relates to the training of large language models for the purpose of generating patent text in accordance with the disclosed method. Training an LLM involves providing the model with suitable input data, which may comprise a diverse and extensive dataset of patent documents or structured documents, and teaching the model to recognize and generate text patterns similar to those found in the input data. The trained LLM may be employed in the generation of long-form patent documents using the data structure of concepts as described herein.

The training process for the LLM may comprise the following steps or components, each of which represents an optional feature that contributes to the effectiveness of the LLM in generating high-quality patent text:
1. Selection of LLM: The selection of an appropriate LLM is a step in the process. The LLM may comprise one from the group consisting of GPT-3.5, GPT-4, or other advanced language models with comparable performance capabilities. The chosen LLM should have the capacity to understand and generate text in a manner that effectively captures the style, structure, and content of patent documents.
2. Compilation of training dataset: The compilation of a diverse and extensive training dataset is for effectively training the LLM. The dataset may comprise various types of documents, such as legal documents, patent publications, technical documents, scientific papers, or technical manuals. The inclusion of these diverse document types in the dataset may enhance the LLM's contextual understanding, enabling it to better comprehend the language, structure, and organization of patent documents.
3. Preprocessing of training dataset: Preprocessing of the training dataset may be performed to improve the quality and consistency of the input data for the LLM. This may comprise cleaning the data by removing irrelevant or redundant information, correcting errors, or converting the data into a suitable format for input into the LLM. Additionally, the preprocessing step may involve segmenting the data into smaller sections, such as paragraphs or individual claims, to facilitate the training process.
4. Training of LLM: The LLM is trained by exposing it to the preprocessed training dataset and adjusting the model's internal parameters to optimize its performance. Regular feedback and evaluation may be employed during the training process to assess the LLM's ability to generate coherent and relevant patent text. The training process may be iteratively repeated until the desired level of performance is achieved.
5. Fine-tuning of LLM: Fine-tuning the LLM may involve adjusting the model's parameters to improve its performance in specific areas, such as generating text that adheres to the conventions of patent terminology and the style of patent documents. This may include adding supplementary data, such as glossaries of technical terms or example claims, to the training dataset. Fine-tuning techniques may also involve adjusting the penalties for generating inappropriate or irrelevant text, thereby refining the LLM's ability to generate patent text that is both informative and adheres to appropriate guidelines and standards.
6. Evaluation and validation of LLM: The evaluation and validation of the trained LLM may involve assessing its performance in generating long-form patent text based on the data structure of concepts. Evaluation metrics or benchmark tests may be established to gauge the quality, coherence, and accuracy of the output text, and revisions may be made to the training process as necessary to achieve the desired performance levels.

In summary, the training of large language models for patent text generation may comprise a series of steps, including the selection of an appropriate LLM, compilation of a diverse and extensive training dataset, preprocessing of the dataset, training the LLM, fine-tuning the model, and evaluating and validating its performance in generating long-form patent text. Each of these steps contributes to the overall effectiveness of the LLM, and the features described allow for customization and optimization in generating high-quality, accurate patent text that aligns with the conventions and standards of the targeted area. The LLM can then be employed in various aspects of the disclosed method to generate patent text based on the data structure of concepts.

### Variations and Additional Outputs in Long-Form Patent Text Generation

This section describes optional features that may be incorporated into the previously discussed method of generating long-form patent texts using AI, specifically Large Language Models. The variations and additional outputs in long-form patent text generation aim to provide a comprehensive and versatile approach to patent generation, which may comprise an array of features to enhance the quality, usability, and adaptability of the generated patent text content.

The following subsections describe the various optional features of the present disclosure, using reference numbers to indicate the features.

### Flexible Language and Industry Variations

The method may comprise generating variations of the long-form patent text based on different parameters, such as target audience, language, and industry-specific terminology. For instance, the AI-generated patent text may be translated or adapted to different languages to cater to a multilingual audience, or it may be tailored to emphasize specific industry terms or concepts to facilitate understanding and application across various sectors.

### Automatic Diagram and Visual Representation Generation

An optional feature in the present disclosure may comprise automatically generating diagrams, visual representations, or other graphical elements of the idea, which provide a visual understanding of the concepts, relationships, and structures underlying the patent text. This feature can utilize the data structure of concepts as a basis for selecting and generating the relevant visual elements to include in the long-form patent text.

### Additional Claim Suggestions

The method may comprise providing suggestions for additional claims based on the concepts identified in the text description and the data structure of concepts. These suggestions can be generated using the AI, and may take into account existing claims, the prior art or other relevant information, to ensure a comprehensive and effective set of claims for the patent application.

### Potential Legal or Technical Issue Identification

The method may comprise identifying potential legal or technical issues that may arise based on the contents of the patent text. This feature leverages the AI's understanding of patent laws and technical standards to evaluate the generated patent text and flag any concerns or issues that may affect the patent application or subsequent use of the patented disclosure.

### Summaries and Abstracts

An optional feature may comprise generating summaries or abstracts of the patent text using the data structure of concepts as a guide. This feature facilitates the quick understanding of the patent content by providing a condensed version that highlights the most important and relevant aspects of the patent text.

### Automatic Table of Contents and Index Generation

The method may comprise automatically generating a table of contents and an index for the long-form patent text, based on the concepts identified in the data structure. This feature ensures easy navigation and reference within the generated patent text, enhancing its usability and organization.

In summary, the present disclosure provides a flexible and comprehensive method for generating long-form patent texts using AI, with various optional features that can be incorporated to enhance the quality, usability, and adaptability of the generated patent text content. These optional features, which may comprise language and industry variations, visual representations, additional claims suggestions, identification of potential legal or technical issues, summaries or abstracts, and automatic table of contents and index generation, provide a robust and complete solution for automated long-form patent text generation.

### Improving Contextual Understanding With Diverse Training Dataset

In certain examples, improving the contextual understanding of the large language model for generating patent texts involves using a diverse training dataset that may comprise a wide variety of document types, sources, and content areas. This diverse training dataset helps to enhance the LLM's ability to understand and generate high-quality patent texts that adhere to specific requirements, formatting, and language nuances. The diverse training dataset may comprise various types of legal documents, patent publications, technical documents, scientific papers, and technical manuals, among others.

In one optional aspect, the diverse training dataset may comprise a large collection of legal documents, ranging from legal briefs, contracts, case summaries, statutes, and regulations to legal memos, articles, and treatises. This inclusion may enable the LLM to learn and contextualize various legal terminologies, phrases, and language patterns that may be relevant for generating patent applications and other legal text outputs.

In another optional aspect, the diverse training dataset may comprise a significant number of patent publications, such as patents and patent applications, from different industries, classifications, and jurisdictions. These patent publications may aid the LLM in understanding the typical structure, format, organization, and language usage within patent documents, as well as the underlying concepts, technologies, and terminologies commonly encountered in patent literature.

In yet another optional aspect, the diverse training dataset may comprise various technical documents relating to different industry sectors, scientific disciplines, and engineering practices. These technical documents may include, but are not limited to, product specifications, design documents, standard operation procedures, test reports, white papers, research reports, and project management documents. These diverse inputs can help the LLM familiarize itself with industry-specific terms, concepts, and language constructs, ultimately assisting in the generation of patent text that is not only accurate but also meaningful and well-suited to a particular field or domain.

Additionally, the diverse training dataset may optionally comprise a broad range of scientific papers across multiple disciplines, such as physics, chemistry, biology, engineering, mathematics, medicine, computer science, social sciences, and humanities. These scientific papers can provide the LL with insights into academic writing styles, research methodologies, scientific terminologies, and data presentation formats, thereby enabling it to create patent applications and other outputs that are consistent with scientific norms and conventions.

In another optional aspect, the diverse training dataset may comprise a collection of technical manuals associated with various products, technologies, systems, and equipment. These technical manuals can expose the LLM to different forms of technical communication, with a focus on instructional and descriptive language, which could facilitate the generation of clear, concise, and informative patent text.

To further enhance the LLM's contextual understanding, the diverse training dataset may optionally include documents from multiple languages, geographical regions, and cultural contexts. This multilingual and multicultural content can help the LLM develop a better grasp of language variances, syntactic structures, and semantic nuances, which in turn may translate into more accurate and higher-quality patent text generation for different languages and target audiences.

Moreover, the diverse training dataset may also optionally incorporate a variety of metadata related to the documents, such as publication dates, document categories, subject classifications, authors, and affiliations. This metadata can enable the LLM to infer implicit relationships, comprehend temporal progressions, and understand the importance of illustrations, tables, and examples within the documents.

In summary, improving the contextual understanding of the LLM for generating patent texts involves assembling a diverse training dataset that may comprise multiple types of legal documents, patent publications, technical documents, scientific papers, and technical manuals, in addition to other optional elements like multilingual and multicultural content and metadata. By training the LLM on this diverse and extensive dataset, the resulting generated patent documents are more likely to reflect a deeper understanding of the various complexities, subtleties, and nuances present in patent text generation, leading to more accurate, informative, and high-quality outputs.

Example 1. A system (100) for generating long-form documents using large language models (LLMs), the system comprising:
a memory (120),
a processor (110) programmed to operate a software comprising: a text description input component (101) configured to collect a text description of an idea;
a data structure conversion component (102) configured to convert the text description of the idea into a data structure of concepts;
an augmentation component (103) configured to augment the data structure of concepts to add concepts and clarify concepts; and
a document generation component (104) configured to generate high quality long-form documents using the data structure of concepts in the AI prompts of the LLM.

Example 2. The system of example 1, wherein the text description input component (101) is configured to collect the text description of the idea through one or more of the following:
a. entering text manually into a web interface;
b. uploading a document containing the text description;
c. importing data from other software applications;
d. extracting text from a web page or other online source; and
e. using a mobile app to capture and submit the text description.

Example 3. The system of example 1 or 2, wherein the data structure of concepts comprises one or more of the following:
a. hierarchical tree structure;
b. semantic graph network;
c. ontology;
d. entity-relationship model;
e. natural language graph;
f. conceptual database schema;
g. concept map;
h. mind map;
i. topic map;
j. semantic web annotations;
k. JSON; and
I. XML.

Example 4. The system of any one of examples 1 to 3, wherein the data structure conversion component (102) is configured to convert the text description of the idea to the data structure of concepts using the LLM.

Example 5. The system of any one of examples 1 to 4, wherein the augmentation component (103) is configured to utilize machine learning algorithms to automatically identify and add concepts to the data structure.

Example 7. The system of any one of examples 1 to 6, wherein the document generation component (104) is configured to generate a detailed patent application text using the data structure of concepts as a guide and using the LLM to fill in relevant details and phrasing.

Example 8. The system of any one of examples 1 to 7, wherein the document generation component (104) is configured to generate variations of the long-form patent text based on different parameters.

Example 9. The system of any one of examples 1 to 8, wherein the document generation component (104) is configured to automatically generate diagrams or visual representations of the idea described in the patent text using the data structure of concepts.

Example 10. The system of any one of examples 1 to 9, wherein the document generation component (104) is configured to provide suggestions for additional examples based on the concepts identified in the text description.

Example 11. The system of any one of examples 1 to 10, wherein the document generation component (104) is configured to identify potential legal or technical issues that may arise based on the contents of the patent text.

Example 12. The system of any one of examples 1 to 11, wherein the document generation component (104) is configured to generate summaries or abstracts of the patent text using the data structure of concepts as a guide.

Example 13. The system of any one of examples 1 to 12, wherein the document generation component (104) is configured to automatically generate a table of contents and index for the long-form patent text based on the concepts identified in the data structure.

Example 15. The system of any one of examples 1 to 14, further comprising a training dataset comprising a collection of legal documents, patent publications, and technical documents, wherein the LLM is trained on the training dataset to improve its understanding of relevant topics and language.

Example 16 A method of generating a patent text using an AI, comprising the steps of: collecting text description of an idea ; converting the text description to a data structure of concepts ; augmenting the data structure of concepts; and generating long-form documents using the data structure of concepts.

Example 17. The method of example 16, wherein the step of collecting the text description of an idea comprises: entering text manually into a web interface; uploading a document containing the text description; importing data from other software applications; extracting text from a web page or other online source; or using a mobile app to capture and submit the text description.

Example 18. The method of example 16 or 17, wherein the data structure of concepts is selected from the group consisting of: a hierarchical tree structure; a semantic graph network; an ontology; an entity-relationship model; a natural language graph; a conceptual database schema; a concept map; a mind map; a topic map; semantic web annotations.

Example 19. The method of any preceding example, wherein the step of converting the text description of an idea to a data structure of concepts utilizes a large language model (LLM).

Example 20. The method of any preceding example, wherein the step of augmenting the data structure of concepts comprises: utilizing machine learning algorithms to automatically identify and add concepts to the data structure; evaluating the existing data structure for completeness, adding missing concepts, or removing irrelevant concepts; or identifying relationships between concepts and adding those relationships to the data structure.

Example 21. The method of any preceding example, wherein the step of generating long-form documents using the data structure of concepts is performed by an LLM that has been trained on a diverse and extensive set of patent documents or structured documents.

Example 22. The method of example 21, wherein the LLM is selected from the group consisting of: GPT-3.5 and GPT-4.

Example 23. The method of any preceding example, wherein generating long-form documents using the data structure of concepts further comprises: creating a detailed patent application using the data structure of concepts as a guide; generating variations of the long-form patent text based on different parameters; automatically generating diagrams or visual representations of the idea; providing suggestions for additional examples; identifying potential legal or technical issues; generating summaries or abstracts of the patent text; or automatically generating a table of contents and index for the long-form patent text.

Example 24. The method of any preceding example, wherein the AI generating the patent text is an LLM, the LLM being trained on a training dataset comprising legal documents, patent publications, technical documents, scientific papers, or technical manuals.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A system for generating long-form documents using large language models (LLMs), the system comprising:
a memory,
a processor programmed to operate a software comprising:
a text description input component configured to collect a text description of an idea;
a data structure conversion component configured to convert the text description of the idea into a data structure of concepts;
an augmentation component configured to augment the data structure of concepts to add concepts and clarify concepts; and
a document generation component configured to generate high quality long-form documents using the data structure of concepts in AI prompts of the-a LLM.

2. The system of claim 1, wherein the text description input component is configured to collect the text description of the idea through one or more of:
a. entering text manually into a web interface;
b. uploading a document containing the text description;
c. importing data from other software applications;
d. extracting text from a web page or other online source; or
e. using a mobile app to capture and submit the text description.

3. The system of claim 1, wherein the data structure of concepts comprises one or more of:
a. hierarchical tree structure;
b. semantic graph network;
c. ontology;
d. entity-relationship model;
e. natural language graph;
f. conceptual database schema;
g. concept map;
h. mind map;
i. topic map;
j. semantic web annotations;
k. JSON; or
l. XML.

4. The system of claim 1, wherein the data structure conversion component is configured to convert the text description of the idea to the data structure of concepts using the LLM.

5. The system of claim 1, wherein the augmentation component is configured to utilize machine learning algorithms to automatically identify and add concepts to the data structure.

6. The system of claim 1, wherein the document generation component is configured to generate a detailed patent application text using the data structure of concepts as a guide and using the LLM to fill in relevant details and phrasing.

7. The system of claim 1, wherein the document generation component is configured to generate variations of a long-form patent text based on different parameters.

8. The system of claim 1, wherein the document generation component is configured to automatically generate diagrams or visual representations of the idea described in a patent text using the data structure of concepts.

9. The system of claim 1, wherein the document generation component is configured to provide suggestions for additional claims based on the concepts identified in the text description.

10. The system of claim 1, wherein the document generation component is configured to identify potential legal or technical issues that may arise based on contents of a patent text.

11. The system of claim 1, wherein the document generation component is configured to generate summaries or abstracts of a patent text using the data structure of concepts as a guide.

12. The system of claim 1, wherein the document generation component is configured to automatically generate a table of contents and index for a long-form patent text based on the concepts identified in the data structure.

13. The system of claim 1, further comprising a training dataset comprising a collection of legal documents, patent publications, and technical documents, wherein the LLM is trained on the training dataset to improve its understanding of relevant topics and language.

14. A method of generating a patent text using an AI, comprising:
collecting text description of an idea;
converting the text description to a data structure of concepts;
augmenting the data structure of concepts; and
generating long-form documents using the data structure of concepts.

15. The method of claim 14, wherein the collecting the text description of an idea comprises:
entering text manually into a web interface;
uploading a document containing the text description;
importing data from other software applications; extracting text from a web page or other online source; or
using a mobile app to capture and submit the text description.

16. The method of claim 14, wherein the data structure of concepts is selected from a group including:
a hierarchical tree structure;
a semantic graph network;
an ontology;
an entity-relationship model;
a natural language graph;
a conceptual database schema;
a concept map;
a mind map;
a topic map; and
semantic web annotations.

17. The method of claim 14, wherein the converting the text description of an idea to a data structure of concepts utilizes a large language model.

18. The method of claim 14, wherein the augmenting the data structure of concepts comprises:
utilizing machine learning algorithms to automatically identify and add concepts to the data structure;
evaluating an existing data structure for completeness, adding missing concepts, or removing irrelevant concepts; or
identifying relationships between concepts and adding those relationships to the data structure.

19. The method of claim 14, wherein the generating long-form documents using the data structure of concepts is performed by an LLM that has been trained on a diverse and extensive set of patent documents or structured documents.

20. The method of claim 19, wherein the LLM is selected from a group including: GPT-3.5 and GPT-4.

21. The method of claim 14, wherein generating long-form documents using the data structure of concepts further comprises:
creating a detailed patent application using the data structure of concepts as a guide;
generating variations of a long-form patent text based on different parameters; automatically generating diagrams or visual representations of the idea;
providing suggestions for additional claims;
identifying potential legal or technical issues;
generating summaries or abstracts of the patent text; or
automatically generating a table of contents and index for the long-form patent text.

22. The method of claim 14, wherein the AI generating the patent text is an LLM, the LLM being trained on a training dataset comprising legal documents, patent publications, technical documents, scientific papers, or technical manuals.
